(19) United States
(12) Patent Application Publication
(10) Pub. No.: US 2010/0009618 A1
(43) Pub. Date: Jan. 14, 2010

(54) AIR DISTRIBUTOR DEVICE OR AIR MIXING DEVICE

(75) Inventors: Wolfgang DIEKSANDER, Filderstadt (DE); Harald HÖRIG, Bischweier (DE); Reinhold Ross, Schwieberdingen (DE)

Correspondence Address: FOLEY AND LARDNER LLP;SUITE 500, 3000 K STREET NW, WASHINGTON, DC, 20007, US

(73) Assignee: BEHR GmbH & Co. KG

(21) Appl. No.: 12/486,368

(22) Filed: Jun. 17, 2009

Related U.S. Application Data
(63) Continuation of application No. 10/556,935, filed on Nov. 16, 2005, now abandoned.

(30) Foreign Application Priority Data
May 16, 2003 (DE) 103 22 457.2

(51) Int. Cl. B60H 1/34

(52) U.S. Cl. 454/155

(57) ABSTRACT

The invention relates to an air distributor device (1) comprising an air conduction housing (2) and a displaceable flap (6) that is located in the air conduction housing (2). Said air conduction housing is equipped with an air inlet (3) and at least two air outlets (4, 5), which can be completely and/or partially sealed by the flap (6). The invention also relates to an air mixing device that is configured in a corresponding manner.

### CROSS-REFERENCE TO RELATED PATENT APPLICATIONS

This application is a Continuation of U.S. application Ser. No. 10/556,935, filed Nov. 16, 2005, which is the National Stage of International Application No. PCT/EP2004/005229, filed May 14, 2004, which is based upon and claims the benefit of priority from prior German Patent Application No. 103 22 457.2, filed May 16, 2003, the entire contents of all of which are incorporated herein by reference in their entirety.

### BACKGROUND

The invention relates to an air distributor device, in particular for air distribution in a ventilation system of a motor vehicle, or to an air mixing device, in particular for regulating the temperature in an air conditioning apparatus of a motor vehicle, according to the preamble of claim 1.

Devices of this type are used for two different applications, that have many features in common. On the one hand, the air distributor device serves as a kind of switch, an air distributor flap dividing inflowing air into two or more airstreams or bunching a plurality of part streams. Switches of this type are used, for example, in the fresh-air/circulation-air housing of a ventilation device of a motor vehicle. On the other hand, air distributor devices of this type may serve for regulating the temperature in an air conditioning apparatus. In this case, a cold-air flap and a warm-air flap, with the aid of which the temperature is regulated, are provided in the air guide housing, in the “maximum heating” state the warm-air flap being opened completely and the cold-air flap closed completely, in the “maximum cooling” state the warm-air flap being closed completely and the cold-air flap opened completely, and, in a regulated state, the two flaps being opened partially.

Thus, the air distributor device known from FR 2 763 286 A1 has a housing with two air inlets arranged at an angle to one another. A moveable flap has a sealing-off wall and two actuating elements, by means of which the flap can be moved into two positions in which it seals off the air inlets. The flap is connected to the housing by means of guides which have the effect that the flap moves in a movement which differs from straightforward rotation. The guides have two curved tracks and two pins which are provided on the flap and are spaced apart from one another and which are guided in the curved tracks.

The known air distributor devices have the disadvantage that at least two flaps are required for each zone of an air conditioning system. In addition, there is the kinematic or electrical coupling, for example via a stepping motor or a U-type socket, such coupling, together with the necessary pivoting travel of the flaps, not allowing a compact type of construction.

### SUMMARY OF PREFERRED EMBODIMENTS

The object of the invention is to make available an improved air distributor device or air mixing device.

This object is achieved by means of an air distributor device or an air mixing device having the features of claim 1. Advantageous refinements are the subject matter of the subclaims.

According to the invention, an air distributor device or an air mixing device is designed in such a way that the air guide housing has provided in it one air inlet and two air outlets or two air inlets and one air outlet which can be closed completely and/or partially by means of the flap. In this case, the two air outlets or air inlets are arranged preferably essentially parallel to one another.

Since in each case one flap is dispensed with, as compared with the prior art, a more compact type of construction is possible. Furthermore, there is no need for mechanical coupling, for example via an actuating lever, with the result that construction space is saved and the hysteresis is reduced. Moreover, the use of a sliding flap affords acoustic benefits.

According to one embodiment, for guiding the flap, two curved tracks arranged one above the other and two pins attached to the flap and aligned with one another are provided. In this case, the curved track is preferably designed to be straight, with essentially straight portions and/or in one radius, although other curved track forms are also possible. Other guides are likewise possible. According to an alternative embodiment, a control peg or a control yoke is provided for guiding the flap.

Preferably, a carrier module is provided, which is inserted into the air guide housing and surrounds the flap together with the guide of the latter. This allows simple preassembly and simplifies final assembly.

The flap may preferably be positioned via an actuating lever, in particular into at least two positions, preferably into any desired positions between two end positions. The actuating lever is preferably connected pivotably to a driveshaft and to the flap, so that only pull and/or push forces take effect.

An air spoiler which positively influences the airflow may be provided at or in the region of the actuating lever.

A sealing edge ensures, particularly in the case of air mixing devices, that there is a separation of cold and warm air.

### BRIEF DESCRIPTION OF THE DRAWINGS

The invention is explained in detail below by means of an exemplary embodiment having variants, with reference to the drawing in which:

FIGS. 1a and 1b show two sectional illustrations of an air distributor device in various positions, the heating position being illustrated on the left and the cooling position on the right in FIG. 1a, and an intermediate position being illustrated on the left and the cooling position on the right in FIG. 1b,

FIGS. 1c and 1d show two sectional illustrations of the air distributor device of FIGS. 1a and 1b with an illustration of the airflow,

FIG. 1e shows a sectional illustration of a detail of the air distributor device of FIG. 1d with an illustration of the airflow,

FIG. 2a-c show a perspective illustration of a first variant of the exemplary embodiment in various positions, the heating position being illustrated in FIG. 2a, an intermediate position in FIG. 2b and the cooling position in FIG. 2c,

FIG. 3a-d show various illustrations of a second variant of the exemplary embodiment,

FIG. 4a-c show various variants of the lever articulation, and

FIG. 5a-e show various curved tracks.

### DETAILED DESCRIPTION OF THE PREFERRED EMBODIMENTS

An air distributor device 1 according to the invention with an air guide housing 2, which is designed in the manner of a switch with one air inlet 3 and with two air outlets 4, 5, has a displaceable flap 6 which, as required, can close the air outlets 4 and 5. In this case, cold air coming from an evaporator is supplied through the common air inlet 3 and, on its way through the air outlet 5, is conducted through a heating body and warmed by the latter. On the way through the air outlet 4, the heating body is bypassed, and therefore no warming of the air takes place. In the present instance, two air distributor devices 1 arranged axially symmetrically are arranged, the two air outlets 5 being located centrally.

Only one of the two air guide devices 1 is described in more detail below. The flap 6, on one side, has two pins 7 which are aligned with one another and are guided in curved tracks 8 formed parallel to one another in the air guide housing 2 and, on its other side, has a pivotably attached actuating lever 9 which, for example, displaces the flap 6 by means of a servomotor (not illustrated).

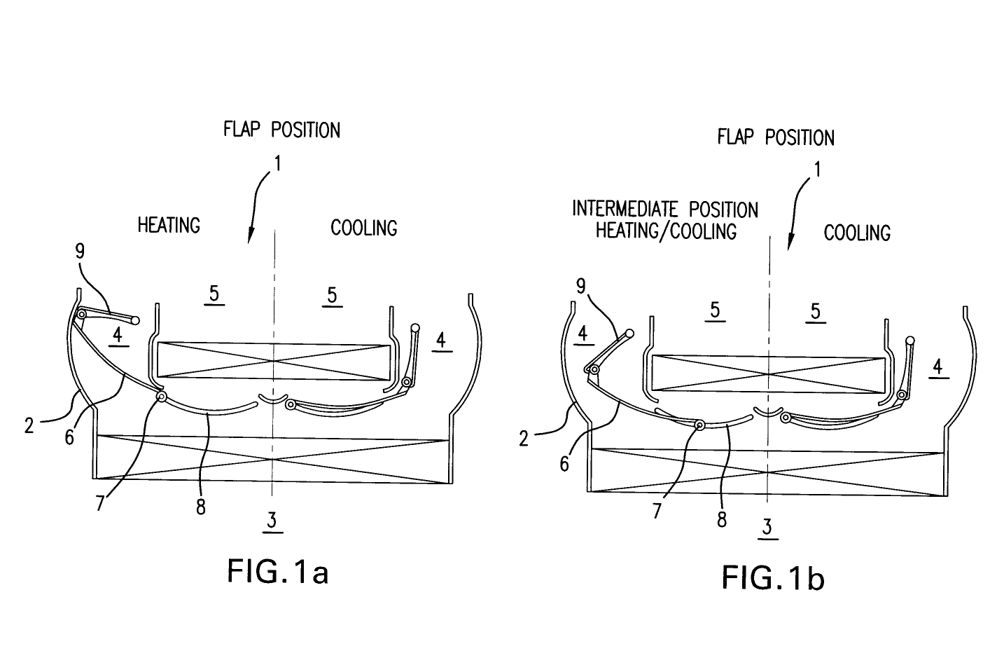

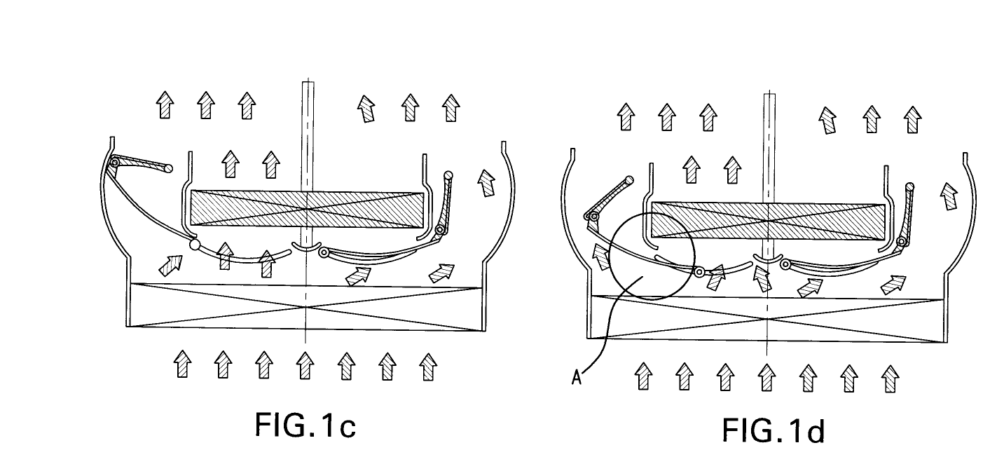

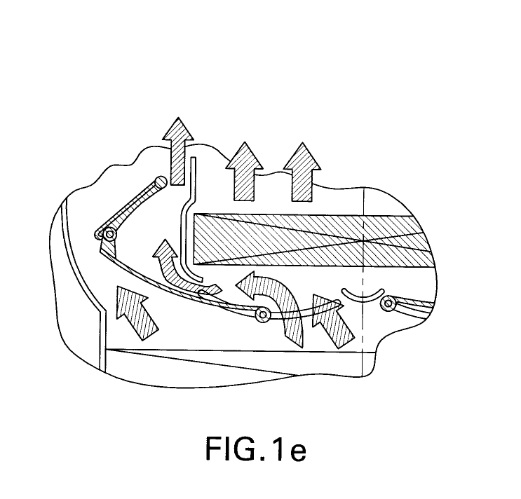

FIG. 1a, left half, shows a first end position of the flap 6, in which the flap 6 closes the air outlet 4 completely and releases the air outlet 5 completely. When the flap 6 is actuated by means of the servomotor, the actuating lever 9 executes essentially a pivoting movement, at the same time taking up that end of the flap 6 which is connected to it, whereas that region of the flap 6 which is located in the vicinity of the pins 7 follows essentially the path of the curved tracks 8. In the intermediate position illustrated on the left in FIG. 1b, both air outlets 4 and 5 are partially released, while, in the second end position illustrated on the right in FIGS. 1a and b, the air outlet 4 is completely open and the air outlet 5 is completely closed. FIG. 1e shows the overflow of the air downstream of the flap 6, with the result that the air flow or the air mixture can be influenced positively. If the overflow is not desired, it can be prevented by means of the movement geometry of the flap 6, for example by the flap 6 coming to bear in the region of the overflow during the movement cycle. A sealing edge in this region can improve this effect.

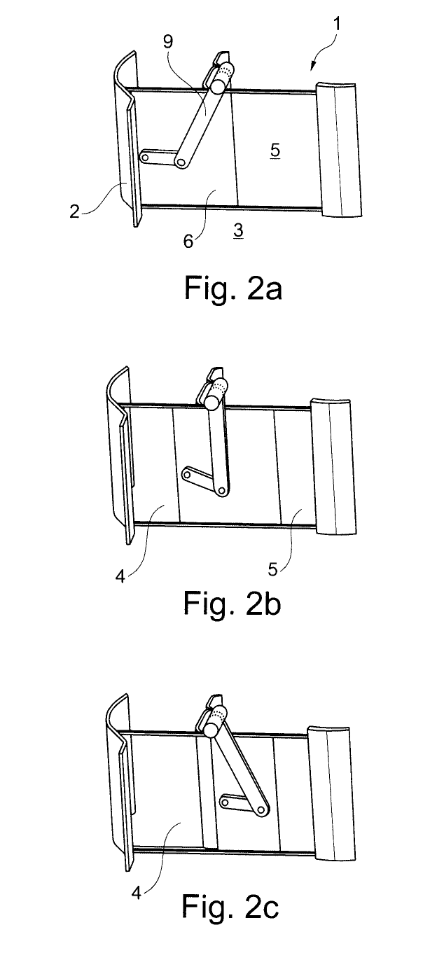

FIG. 2a-c show a first variant with straight curved tracks and in which the flap 6 executes a straightforward longitudinal movement. Identical or identically acting components are designated by the same reference symbols as in the exemplary embodiment described above, without these being described in any more detail. The sliding flap 6 may be controlled, during movement, as a function of the shape of the guide track, in such a way that the flap 6 bears against the sealing frame in the two end positions, but runs freely in the intermediate positions.

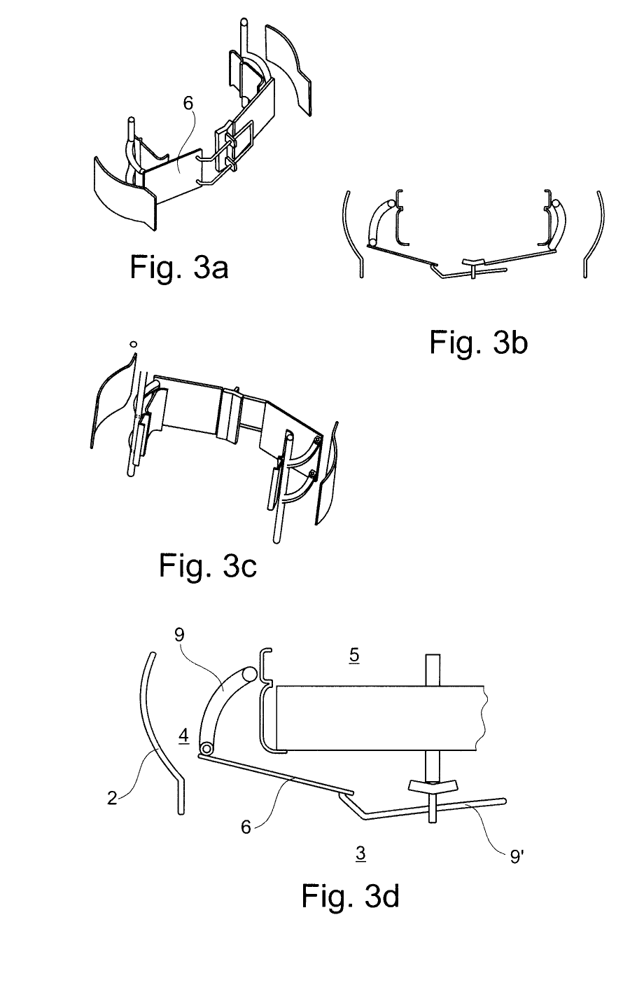

According to a variant illustrated in FIG. 3a-d, guidance takes place via a control peg 9′, in which case the pins and curved tracks may be dispensed with.

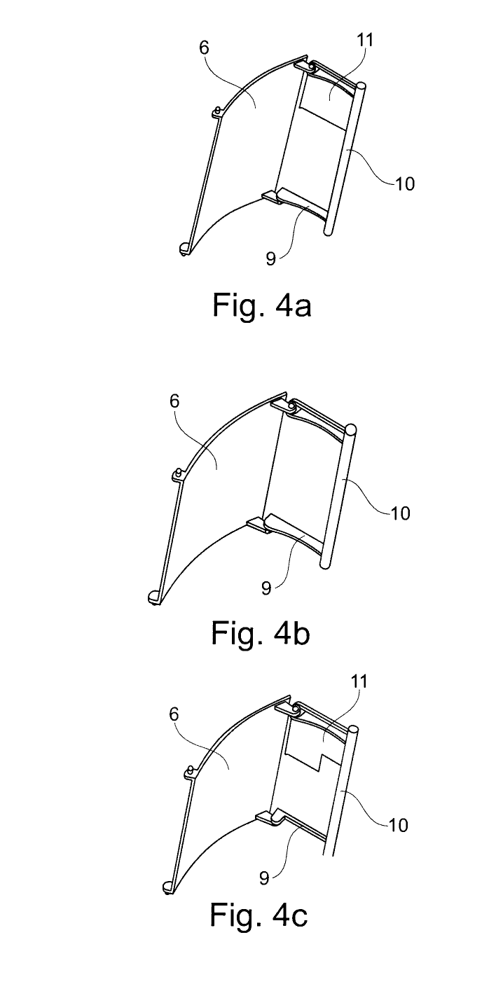

FIG. 4a-c show different variants of the lever articulation of the actuating lever or actuating levers 9. In this case, two actuating levers 9 are in each case connected at their “free” ends pivotably to the flap 6 and at their other ends, for reasons of stability, to a driveshaft 10, one actuating lever 9 being articulated in the upper region of the flap 6 and one actuating lever 9 being articulated in the lower region of the latter. According to a variant illustrated in FIG. 4a, a guide spoiler 11 for air guidance is provided, which runs over about half the flap height. In the second variant illustrated in FIG. 4b, there is no guide spoiler provided. The third variant illustrated in FIG. 4c has an L-shaped guide spoiler 11, one leg of which runs between the driveshaft 10 and flap 6 and the other leg of which runs near the flap 6 parallel to the driveshaft 10 toward the lower actuating lever 9. The air spoiler 11 has an effect on the air mixture. The air spoiler 11 may also have other forms of construction, for example three-dimensional shapes, for defined air guidance.

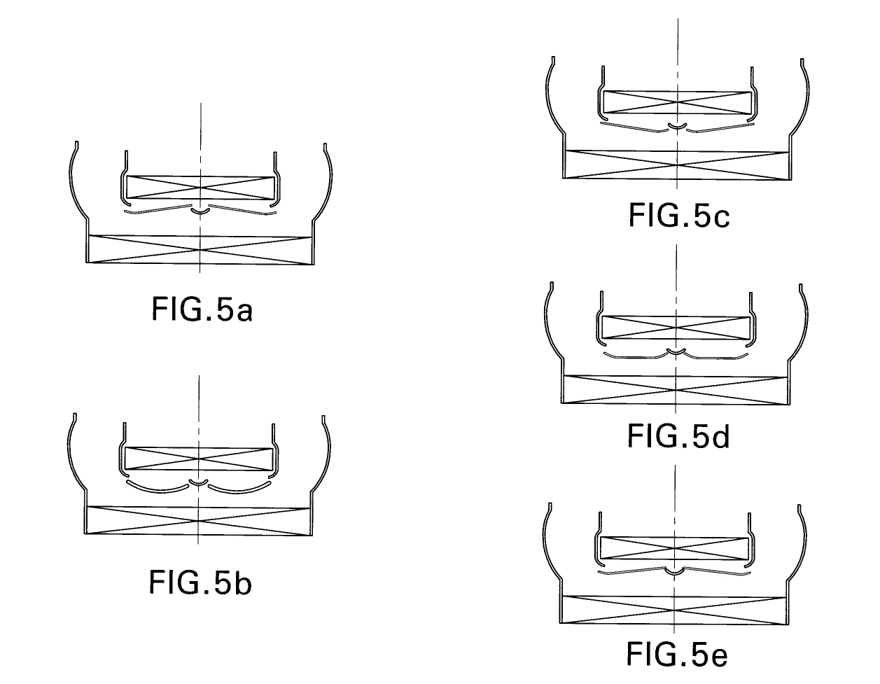

FIGS. 5a-e show various variants of curved tracks along which the pins can be guided. Normally, guidance takes place via two pairs of aligned pins, although, for example, only one pair of aligned pins and a single pin arranged on the opposite side may also be arranged. Further pin arrangements are possible. If the curved tracks are designed in such a way that the flap does not rub, that is to say, during adjustment, it is first moved away from its bearing surfaces, then a reduced effort is required for adjustment and the useful life of seals is increased.

The figures do not illustrate any sealing edges which may be located on the flap and/or on the carrier module.

By a reversal of direction, that is to say a reversed airflow direction, the air distributor devices described above become air mixing devices.

### LIST OF REFERENCE SYMBOLS

1 Air distributor device
2 Air guide housing
3 Air inlet
4, 5 Air outlets
6 Flap
7 Pins
8 Curved track
9 Actuating lever
9′ Control peg
10 Driveshaft
11 Guide spoiler

1-11. (canceled)

12. An air distributor device comprising an air guide housing comprising an adjustable flap, an air inlet, two air outlets, two curved tracks arranged one above the other to guide the adjustable flap, two pins attached to the adjustable flap, and an actuating lever connected pivotably to a driveshaft and to the adjustable flap,
wherein the two air outlets can be closed completely or partially by the adjustable flap.

13. An air mixing device comprising an air guide housing comprising an adjustable flap, two air inlets, an air outlet, two curved tracks arranged one above the other to guide the adjustable flap, two pins attached to the adjustable flap, and an actuating lever connected pivotably to a driveshaft and to the adjustable flap, wherein the two air outlets can be closed completely or partially by the adjustable flap.

14. The air distributor device as claimed in claim 12, wherein the curved track is straight, has straight portions or is in one radius.

15. The air distributor device as claimed in claim 12 further comprising a control peg or a control yoke, wherein the control peg or control yoke guides the adjustable flap.

16. The air distributor device as claimed in claim 12 further comprising-a carrier module in the air guide housing.

17. The air distributor device as claimed in claim 12, wherein the actuating lever further comprises an air spoiler.

18. The air distributor device as claimed in claim 12, wherein a sealing edge is formed.

19. The air distributor device as claimed in claim 12, wherein the two air outlets are oriented parallel to one another.

20. The air mixing device as claimed in claim 13, wherein the curved track is straight, has straight portions or is in one radius.

21. The air mixing device as claimed in claim 13, further comprising a control peg or a control yoke, wherein the control peg or control yoke guides the adjustable flap.

22. The air mixing device as claimed in claim 13, further comprising a carrier module in the air guide housing.

23. The air mixing device as claimed in claim 13, wherein the actuating lever further comprises an air spoiler.

24. The air mixing device as claimed in claim 13, wherein a sealing edge is formed.

25. The air mixing device as claimed in claim 13, wherein the two air inlets are oriented parallel to one another.

26. The air distributor device as claimed in claim 12, wherein the two pins are guided in the curved tracks.

27. The air mixing device as claimed in claim 13, wherein the two pins are guided in the curved tracks.

28. The air distributor device as claimed in claim 12, wherein the two curved tracks guide the adjustable flap via contact with the two pins attached to the adjustable flap.

29. The air mixing device as claimed in claim 13, wherein the two curved tracks guide the adjustable flap via contact with the two pins attached to the adjustable flap.

30. An air distributor device comprising:
an air guide housing comprising:
a plurality of adjustable flaps,
an air inlet,
a plurality of air outlets,
a plurality of curved tracks configured to guide the adjustable flap,
at least one pin attached to a respective adjustable flap, and
an actuating lever connected pivotably to a driveshaft and to the respective adjustable flap,
wherein the two air outlets can be closed completely or partially by the plurality of adjustable flaps.
